(19) United States
(12) Patent Application Publication
(10) Pub. No.: US 2005/0285974 A1
(43) Pub. Date: Dec. 29, 2005

(54) Apparatus and method of smoothing video signal using pattern adaptive filtering

(76) Inventor: Sung-hee Kim, Seoul (KR)

Correspondence Address: STANZIONE & KIM, LLP, 919 18TH STREET, N.W., SUITE 440, WASHINGTON, DC, 20006, US

(21) Appl. No.: 11/092,918

(22) Filed: Mar. 30, 2005

(30) Foreign Application Priority Data
Jun. 8, 2004 (KR) 2004-41933

(51) Int. Cl. G06K 9/38

(52) U.S. Cl. 348/448

(57) ABSTRACT

An apparatus and a method to smooth an input image are provided. A filter kernel mask is determined according to detected pattern information of the input image and applies a non-linear filtering to the input image. One or more masks each having a predetermined pattern are used to detect the pattern information of an input image, a similarity between the input image and each of the one or more masks is measured, a mask that is most appropriate for the input image is determined according to the measured similarity, and a non-linear filtering is applied using the determined mask. Since a noise measurement according to an input image is not required, a problem of a noise measurement value varying according to characteristics of a video signal may be avoided. Further, since a non-linear filtering is applied, it is possible to conserve edge information of the input image.

### CROSS-REFERENCE TO RELATED APPLICATIONS

This application claims the benefit of Korean Patent Application No. 2004-41933 filed on Jun. 8, 2004 with the Korean Intellectual Property Office, the disclosure of which is incorporated herein in its entirety by reference.

### BACKGROUND OF THE INVENTION

1. Field of the Invention

The present general inventive concept generally relates to an apparatus and a method of smoothing a video signal. More particularly, the present general inventive concept relates to an apparatus and a method of smoothing a video signal using a pattern adaptive filtering, in which noise can be removed from input video signals and resolution can be improved by performing a non-linear filtering according to patterns of the input video signals.

2. Description of the Related Art

Generally, noise in a video signal is a primary factor in deterioration of a video signal and a reduction in video encoding and decoding performances. As a result, various noise cancellation technologies have been developed in an attempt to improve a picture quality and the video encoding and decoding performances.

Image filtering is a type of image processing, such as an edge enhancement and a noise cancellation, which is achieved by performing a local operation on all pixels in an image. The local operation determines an output gray scale value of an arbitrary pixel in the image from input gray scale values of pixels adjacent to the arbitrary pixel. The local operation is independently performed on each pixel in the image and a neighborhood of each pixel is sufficiently small compared with the size of the entire image. A number of non-linear filtering technologies have been developed even though analysis and realization of the non-linear filter is difficult due to a blurring in a sharpness of an edge portion of an image.

In conventional filter technologies, a spatial noise reducer and a temporal noise reducer are used for noise reduction. The spatial noise reducer performs a low-pass filtering in a space area of a video signal, and the temporal noise reducer performs a low-pass filtering in a time direction of the video signal output from the spatial noise reducer.

However, since the spatial noise reducer reduces not only the noise of the video signal but also a high frequency component of the video signal, an image of the video signal may be damaged. The temporal noise reducer also has a problem in that the effect of the noise reduction decreases as a motion degree of an image increases. Furthermore, a noise measurement value may vary depending on a sum of absolute difference (SAD) distribution of the video signal. Thus, the video signal may be damaged by the noise reducers.

### SUMMARY OF THE INVENTION

Aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of smoothing a video signal using a pattern adaptive filtering, which includes receiving an input image and determining a corresponding input image matrix, computing one or more correlation coefficients by relating one or more masks having predetermined patterns to the input image matrix so that a center of the one or more masks is matched with an object pixel of the input image matrix using at least one predetermined window matrix of the input image matrix, determining a filter mask to use to filter the object pixel of the input image by selecting one of the one or more masks having a maximum correlation coefficient with the at least one predetermined window matrix having the object pixel, and performing a non-linear filtering to determine an output object pixel value of the input image using the determined filter mask. The non-linear filtering may select an arbitrary value from among pixel values of the at least one predetermined window matrix of the input image that correspond to the predetermined pattern of the determined filter mask.

Each of the one or more masks may be a square matrix having a plurality of fields including a plurality of pattern fields filled with the same values such that the selected the plurality of pattern fields define one of a unidirectional pattern, a bidirectional pattern, and an omnidirectional pattern.

Each of the one or more masks may be a square matrix having a plurality of fields including a plurality of pattern fields filled with different weighted values such that the weighted values are selected to define one of a unidirectional pattern, a bidirectional pattern, and an omnidirectional pattern.

Each of the one or more masks may be a square matrix having a plurality of fields including a plurality of pattern fields to define a corresponding pattern of the respective mask. The plurality of pattern fields may be configured so that a sum of values filled in the plurality of pattern fields equals 1 and a remainder of the plurality of fields (i.e., a plurality of non-pattern fields) may be filled with zero so that the respective computed correlation coefficient is normalized.

The performing of the non-linear filtering may comprise performing a median filtering to select the output object pixel value from among values of the at least one predetermined window matrix of the input image matrix that correspond to the plurality of pattern fields of the determined filter mask.

The foregoing and/or other aspects and advantages of the present general inventive concept may be achieved by providing an apparatus to smooth a video signal using a pattern adaptive filtering, which includes a correlation measurement block to compute one or more correlation coefficients by relating one or more masks to an input image matrix so that a center of the one or more masks is matched with an object pixel of the input image matrix using at least one predetermined window matrix of the input image matrix, a pattern determination block to determine a filter mask to use to filter the object pixel of the input image by selecting one of the one or more masks having a maximum correlation coefficient with the at least one predetermined window matrix according to the computed one or more correlation coefficients, and a pattern adaptive non-linear filter block to perform a non-linear filtering to determine an output object pixel using the determined filter mask. The pattern adaptive non-linear filter block may select a value of the output object pixel from among pixel values of the at least one predetermined window matrix of the input image matrix that correspond to the predetermined pattern of the determined filter mask.

Each of the one or more masks may be a square matrix having a plurality of fields including a plurality of pattern fields filled with the same values and the plurality of pattern fields may define one of a unidirectional pattern, a bidirectional pattern, and an omnidirectional pattern.

Each of the one or more masks may be a square matrix having a plurality of fields including a plurality of pattern fields filled with different weighted values and the weighted values may define one of a unidirectional pattern, a bidirectional pattern, and an omnidirectional pattern.

Each of the one or more masks may be a square matrix having a plurality of fields including a plurality of pattern fields to define a corresponding pattern of the respective mask and may be configured so that a sum of values filled in the plurality of pattern fields equals 1 and remainders of the plurality of fields (i.e., a plurality of non-pattern fields) are filled with zero.

The pattern adaptive non-linear filter block may perform a non-linear filtering to select the output object pixel value from an intermediate value, a maximum value, and a minimum value of pixel values of the at least one predetermined window matrix that correspond to the plurality of pattern fields of the determined filter mask.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a non-linear filtering apparatus that filters input video signals depending on patterns of the input video signals according to an embodiment of the present general inventive concept;

FIG. 2 is a view illustrating filtering masks used to determine a pattern of an input image according to an embodiment of the present general inventive concept;

FIGS. 3A and 3B are views illustrating an operation of a correlation measurement block of the non-linear filtering apparatus of FIG. 1;

FIG. 4 is a view illustrating an operation of a correlation measurement block and a pattern adaptive filter block of the non-linear filtering apparatus of FIG. 1; and

FIG. 5 is a flowchart illustrating a method of smoothing a video signal using a pattern adaptive filtering according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

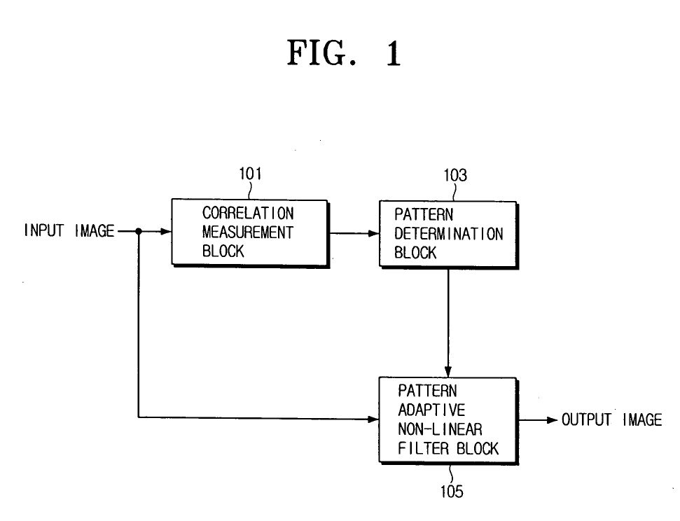

FIG. 1 is a block diagram illustrating an apparatus to smooth a video signal using a pattern adaptive filtering according to an embodiment of the present general inventive concept. Referring to FIG. 1, a smoothing apparatus includes a correlation measurement block 101, a pattern determination block 103, and a pattern adaptive non-linear filter block 105.

The correlation measurement block 101 and the pattern determination block 103 determine a filter kernel mask (referred to as a ‘mask’) according to pattern information detected from an input image. The pattern adaptive non-linear filter block 105 applies a non-linear filtering to the input image according to the pattern information detected by the correlation measurement block 101 and the pattern determination block 103. More specifically, the correlation measurement block 101 sets one or more predetermined masks to correspond with one or more patterns defined in advance and measures similarities between the input image and the one or more predetermined masks so as to detect the pattern information of the input image. The pattern determination block 103 selects a filter kernel mask from the one or more predetermined masks that is most appropriate to filter the input image pattern according to the measured similarities.

The correlation measurement block 101 may have a plurality of predetermined masks (i.e., the masks set in advance) and obtains a correlation coefficient between each predetermined mask and the input image. In order to obtain each correlation coefficient, the correlation measurement block 101 opens a window that corresponds to a specific predetermined mask, where a pixel to be filtered (referred to as an ‘object pixel’) in the input image is centered, and obtains the respective correlation coefficient. In other words, each of the plurality of predetermined masks is compared to the window with respect to the object pixel.

The input image may be a digitized video signal and includes an intensity value of each pixel that has passed through a quantization process. According to an embodiment of the present general inventive concept, the input image of one frame may be expressed in a matrix form including an intensity value of each pixel. If the input image is quantized according to 8 bits, the intensity value of each pixel in the input image matrix may be values between 0 and 255. A noise may be induced in an input image. Typically, a white Gaussian noise may be induced. The present general inventive concept restores an original input image by filtering out the white Gaussian noise. The filtering is performed independently for each pixel and an output image is generated including filtered (i.e., newly selected) intensity values (referred to as a ‘gray-scale’ value) of each of the pixels.

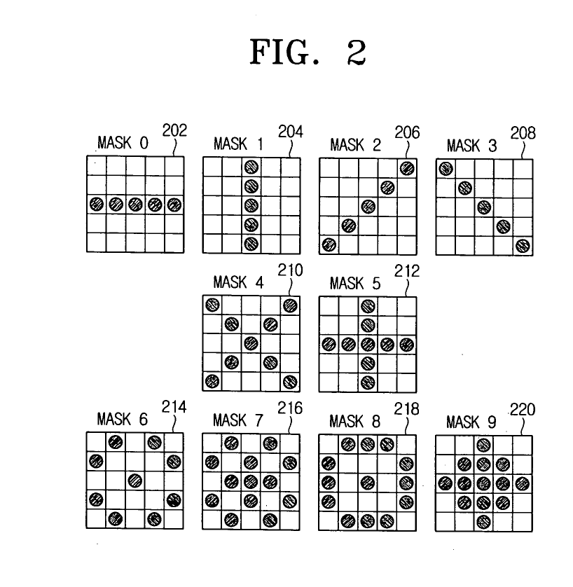

The correlation measurement block 101 includes at least one mask. According to an embodiment of the present general inventive concept, the correlation measurement block 101 may include up to ten masks. Other numbers of masks may also be used by the correlation measurement block 101. Ten masks that may be included in the correlation measurement block 101 are illustrated in FIG. 2.

FIG. 2 is a view illustrating a filtering mask used to determine a pattern of an input image according to an embodiment of the present general inventive concept. Although FIG. 2 illustrates ten masks having corresponding mask patterns, it should be understood other mask patterns may be used with the present general inventive concept. In an embodiment of the present general inventive concept, each mask may be realized by a 5×5 square matrix. Other matrix sizes may also be used. Further, a matrix having an odd number of columns and rows may be used.

Referring to FIG. 2, the masks include a unidirectional mask, a bidirectional mask, and an omnidirectional mask. A mask 0, a mask 1, a mask 2, and a mask 3 represent unidirectional masks. A mask 4 and a mask 5 represent bidirectional masks, and a mask 6, a mask 7, a mask 8, and a mask 9 are omnidirectional masks. Fields represented by a black dot in the mask (i.e., pattern fields) correspond to non-zero values 3. The same value may be used within one mask or different weighted values may be used as the non-zero values.

The masks may be normalized so that the sum of fields that correspond to the black dots within a single mask may equal 1. This normalization prevents results from being influenced as the number of black dots for each mask varies. For example, with reference to the mask 0, since the mask 0 includes five black dots, the fields may have same values of ⅕, ⅕, ⅕, ⅕, and ⅕, respectively. With reference to the mask 6, since the mask 6 includes nine black dots, values of the fields that correspond to the nine black dots may all be 1/9. For an example where a value is weighted, with reference to the mask 0, weighted values of ⅛, ⅛, ½, ⅛, and ⅛ may correspond to the relevant fields, and a sum of the values of the relevant fields equals 1. The rest of the fields of the matrix except for the black dots (i.e., remaining non-pattern fields) are filled with the same values, so that a pattern is formed. The rest of the fields of the matrix (except for the pattern fields) may correspond to a value of 0.

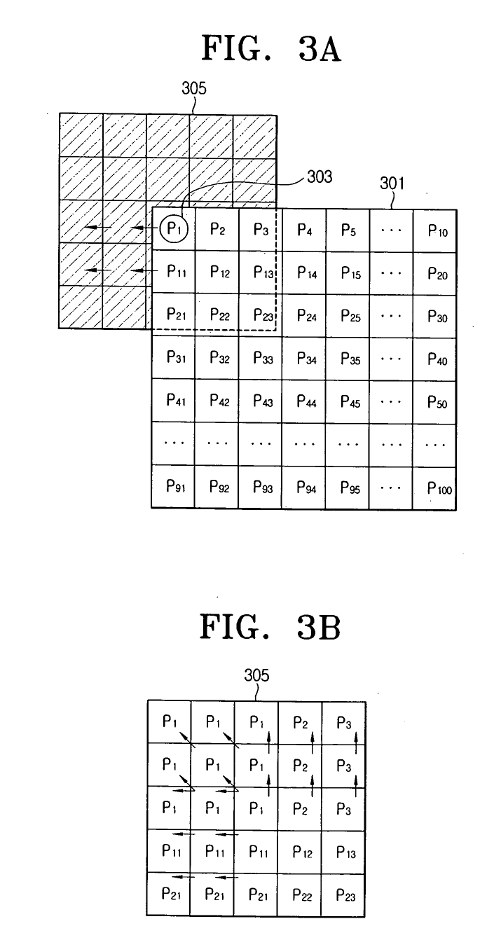

FIGS. 3A and 3B are views illustrating an operation of the correlation measurement block 101 of FIG. 1. FIGS. 3A and 3B illustrate a separate window set to relate an input image to a mask. Referring to FIGS. 3A and 3B, a window 305 of a 5×5 matrix having an object pixel 303 of an input image matrix 301 at a center thereof, which corresponds to a mask of FIG. 2, is opened. The window 305 is meant to correspond with a portion of the input image matrix 301 having the object pixel 303 at a center threreof that is to be compared to the predetermined masks to determine the correlation coefficients. Therefore, the window 305 is typically the same matrix size as the predetermined masks.

FIG. 3B illustrates a method of opening the window 305 having a pixel value P1 of the input image matrix 301 (i.e., the object pixel 303) corresponds with a center of the window 305. With reference to the pixel value P1 of the input image matrix 301 (i.e., a first pixel), a “start-effect” is generated due to an absence of an input image value in the input image matrix 301 to correspond with uppermost and leftmost parts (represented by oblique arrows in FIGS. 3A and 3B) of the window 305. The start-effect occurs at P2, P3, P4, P6, P11, P21, and P31 of the input image matrix 301. A similar “end effect” occurs at P10, P20, P30, and P40, located at the opposite side of the input image matrix 301. The start and end effects occur when comparing the mask to pixels that are close to edges of the input image matrix 301. To prevent inappropriate values from being computed to fill the values not filled in the open window 305, the present general inventive concept fills a neighboring value into parts where an input image value has not been filled in the open window 305. As illustrated in FIGS. 3A and 3B, the pixel values of P1, P2, P3, P11, and P21 are used to fill in values in the open window 305. Accordingly, a correlation coefficient may accurately be obtained by the correlation measurement block 101 (see FIG. 1).

FIG. 3B illustrates a method used to fill values of an open window 305. That is, vacant parts in the open window 305 are filled with a neighboring value of the input image matrix 301 (see FIG. 3A).

If a filtering is performed and a gray-scale is obtained for an object pixel, a pre-obtained gray-scale value may be included in an open window to perform a filtering to obtain a gray-scale value of the next object pixel to be filtered.

The correlation measurement block 101 (see FIG. 1) may relate the open window 305 to the ten predetermined masks of FIG. 2 to obtain a correlation coefficient for each of the predetermined masks. Computation of a correlation coefficient may be performed by a conventional method.

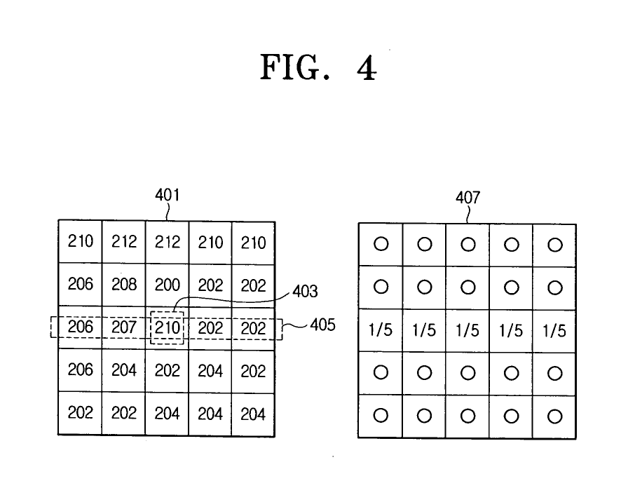

FIG. 4 is a view illustrating an operation of the correlation measurement block 101 and the pattern adaptive non-linear filter block 105 of FIG. 1. FIG. 4 illustrates an open window 401 (similar to 305 in FIGS. 3A and 3B) with an object pixel 403 centered and a mask 407 that corresponds to the mask 0 of FIG. 2. The correlation measurement block 101 (see FIG. 1) matches the object pixel 403 with a center of the mask 407 (i.e., the mask 0 of FIG. 2) and computes a correlation coefficient.

Ten correlation coefficients for the ten masks illustrated in FIG. 2 are, respectively, obtained for a single object pixel (i.e., 403) and computation of correlation coefficients for all pixels in an input image is sequentially performed beginning with a first pixel of the input image of one frame so that the correlation coefficients can be obtained for all the pixels in the input image. Further, a mask having a maximum correlation coefficient is determined for each of the pixels in the input image so that each of the pixels in the input image can be filtered according thereto.

The pattern determination block 103 determines a mask having the maximum correlation coefficient computed by the correlation measurement block 101 from the predetermined masks 202 through 220 of FIG. 2. The predetermined mask that is most similar to an object pixel is determined to be a filter kernel mask for the object pixel. The pattern determination block 103 determines a filter kernel mask for each pixel in the input image by determining which of the predetermined masks has a maximum correlation coefficient for each pixel in the input image.

The pattern adaptive non-linear filter block 105 performs a filtering of the input image using the filter kernel mask determined by the pattern determination block 103 and generates an output image according thereto. The filtering is performed using a rank-order static filter. A median filter may be used. The median filtering may be performed by the following equation.
Y(N)=med[X(n−K), . . . , X(n), . . . , X(n+K)] [Equation 1]

In Equation 1, Y(N) is a filtered value and a med[ ] is a function to determine a median value. X(n) is a pixel value of the input image that corresponds to a position of a black dot of the filter kernel mask. X(n) is defined by (2×K)+1. That is, if a mask 9 of FIG. 2 is determined to be the filter kernel mask, the total number of block dots is 13 and K is equal to 6. Therefore, K ranges among values −6, −5, 4, −3, −2, −1, 0, 1, 2, 3, 4, 5, and 6.

As illustrated in FIG. 4, an input value of the object pixel 403 in the open window 401 is 210. If the mask 407 (i.e., the mask 0 of FIG. 2) is determined to be the filter kernel mask for the object pixel 403, the median filtering is performed using values of a row 405 of the open window 401, which are input image values that correspond to the black dots of the mask 407 (the mask 0 of FIG. 2). Thus, the med[ ] function is applied to the input image values of the row 405 including 206, 207, 210, 202, and 202. Therefore, 206 is the median value and becomes a gray-scale value of the output image at the object pixel 403.

A maximum value or a minimum value may alternatively be used as a representative value instead of the median value. Therefore, a non-linear filtering to set an arbitrary order and adopt a value having the arbitrary order as the representative value may be performed.

The median filter as compared to a low-pass filter enables image information about an edge in the input image to be conserved.

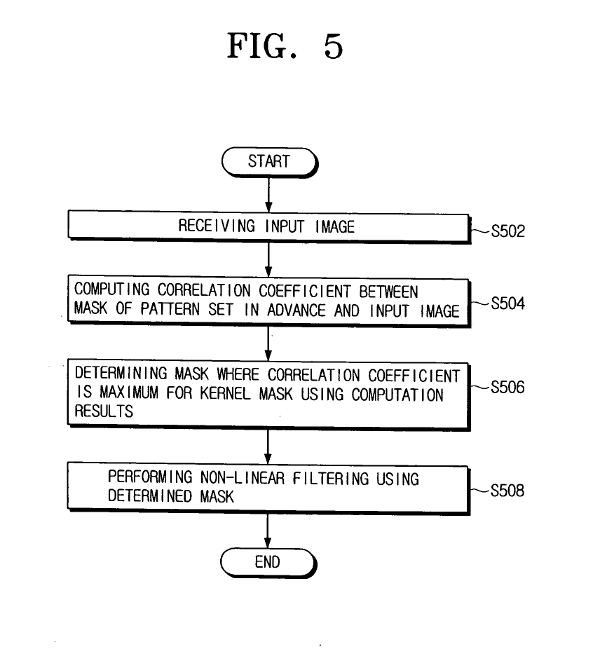

FIG. 5 is a flowchart illustrating a method of smoothing a video signal using a pattern adaptive filtering according to an embodiment of the present general inventive concept.

An input image matrix is received (S502), and a correlation coefficient between one or more predetermined masks having corresponding patterns is computed for each pixel of the input image matrix (S504).

A predetermined mask having a maximum value among one or more computed correlation coefficients is determined as a kernel mask for each respective pixel in the input image matrix (S506).

A non-linear filtering is performed using the kernel mask of each pixel in the input image matrix (S508).

As described above, since a noise measurement according to an input image is not required, a problem of a noise measurement value varying according to characteristics of a video signal may be avoided. Furthermore, since a non-linear filtering is applied, it is possible to conserve edge information of the input image. Therefore, an edge region is conserved and the input image can be smoothly processed. In particular, the present general inventive concept shows excellent performance for an impulse noise.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of smoothing a video signal using a pattern adaptive filtering, the method comprising:
receiving an input image and determining a corresponding input image matrix;
computing one or more correlation coefficients by relating one or more masks having predetermined patterns to the input image matrix so that a center of the one or more masks is matched with an object pixel of the input image matrix using at least one predetermined window matrix of the input image matrix;
determining a filter mask to filter the object pixel of the input image by selecting one of the one or more masks having a maximum correlation coefficient with the at least one predetermined window matrix; and
performing a non-linear filtering to determine an output object pixel value of the input image using the determined filter mask.

2. The method of claim 1, wherein the performing of the non-linear filtering comprises selecting an arbitrary value from among pixel values of the input image matrix that correspond to the predetermined pattern of the determined filter mask.

3. The method of claim 1, wherein each of the one or more masks comprises a square matrix having a plurality of fields including a plurality of pattern fields filled with the same values, and the plurality of pattern fields having the same values defines one of a unidirectional pattern, a bidirectional pattern, and an omnidirectional pattern.

4. The method of claim 1, wherein each of the one or more masks comprises a square matrix having a plurality of fields including a plurality of pattern fields filled with different weighted values, and the weighted values define one of a unidirectional pattern, a bidirectional pattern, and an omnidirectional pattern.

5. The method of claim 1, wherein each of the one or more masks comprises a square matrix having a plurality of fields including a plurality of pattern fields to define a corresponding pattern of the respective mask and is configured so that a sum of values filled in the plurality of pattern fields equals 1 and remainders of the plurality of fields are filled with zero.

6. The method of claim 1, wherein the performing of the non-linear filtering comprises performing a median filtering to select the output object pixel value from values of the at least one predetermined window matrix of the input image matrix that correspond to the predetermined pattern of the determined filter mask.

7. The method of claim 6, wherein the plurality of pattern fields define the corresponding pattern of the determined filter mask and the non-linear filtering is performed according to:
Y(N)=med[X(n−K), . . . , X(n), . . . , X(n+K)]
where Y(N) is the output object pixel value, X(n) includes the values of the at least one predetermined window matrix that correspond to the plurality of pattern fields of the determined filter mask, med[ ] is a function that selects a median pixel value from among the X(n) values, and K is a variable that ranges from a negative to a positive value of: (a number of pattern fields−1)/2.

8. The method of claim 1, wherein the one or more predetermined masks having predetermined patterns comprise a plurality of masks having predetermined patterns, and all object pixels in the input image matrix are filtered according to a filter mask selected from the plurality of predetermined masks having a maximum correlation with pixels surrounding each of the object pixels.

9. A method of filtering an input image in a video signal, the method comprising:
determining a pattern of the input image by comparing the input image to a plurality of predetermined masks;
selecting at least one filter mask that is most similar to the input image from the plurality of predetermined masks; and
filtering the input image according to the selected at least one filter mask.

10. The method of claim 9, wherein:
the determining of the pattern of the input image comprises determining at least one correlation between at least one predetermined mask having a corresponding pattern and each pixel in the input image,
the selecting of the at least one filter mask that is most similar to the input image from the plurality of predetermined masks comprises selecting the at least one filter mask having a maximum correlation from the plurality of predetermined masks for each pixel in the input image, and
the filtering of the input image according to the selected at least one filter mask comprises filtering each pixel in the input image according to the respective ones of the at least one filter mask for each pixel in the input image.

11. The method of claim 9, wherein the determining of the pattern of the input image comprises, for each pixel in the input image:
defining a window matrix having pixel values of the input image including an object pixel at a center thereof; and
comparing each of the plurality of predetermined masks with the window matrix to measure a similarity between the window matrix and each of the plurality of predetermined masks.

12. The method of claim 11, wherein each of the plurality of predetermined masks has a plurality of pattern fields and non-pattern fields to define a corresponding pattern, and the window matrix has a plurality of fields including pixel values of the input image.

13. The method of claim 12, wherein when the object pixel is close to an edge of the input image,
determining unfilled fields in the window matrix that do not have a corresponding input image pixel value; and
filling the unfilled fields in the window matrix with a nearest corresponding input image pixel value.

14. The method of claim 9, wherein the selecting of the at least one filter mask that is most similar to the input image comprises, for each pixel in the input image:
comparing a matrix window having pixel values of the input image including an object pixel at a center thereof to each of a plurality of predetermined masks; and
selecting the filter mask that is most similar to the matrix window according to the pixel values in the matrix window and patterns of each of the plurality of predetermined masks.

15. The method of claim 9, wherein the filtering of the input image according to the selected at least one filter mask comprises a non-linear filtering process performed for each of the pixels in the input image.

16. The method of claim 9, wherein each of the plurality of predetermined masks comprises a plurality of pattern fields and non-pattern fields to define a corresponding pattern, and a window matrix of the input image having an input object pixel at a center thereof includes a plurality of fields including pixel values of the input image, and the non-linear filtering process comprises, for each pixel in the input image:
comparing the matrix window of the input image having the input object pixel at the center thereof to the selected filter mask to determine pixel values of fields in the matrix window that correspond to the pattern fields in the selected filter mask; and
selecting one of the pixel values of the fields in the matrix window that correspond to the pattern fields in the selected filter mask as an output object pixel value.

17. The method of claim 16, wherein selecting one of the pixel values of the fields in the matrix window that correspond to the pattern fields of the selected filter mask comprises selecting one of a median pixel value, a maximum pixel value, and a minimum pixel value.

18. The method of claim 9, wherein each of the plurality of predetermined masks has a predetermined mask size that corresponds to a portion of the input image to filter an object pixel of the input image, and the plurality of predetermined masks include at least one of a bidirectional pattern, a unidirectional pattern, and an omnidirectional pattern.

19. The method of claim 9, wherein:
the determining of the pattern of the input image comprises determining at least one pattern of the input image by comparing the plurality of predetermined masks having corresponding patterns to the input image,
the selecting of the at least one filter mask that is most similar to the input image from the plurality of predetermined masks comprises selecting the at least one filter mask from the plurality of predetermined masks that has a corresponding pattern that is similar to the at least one pattern of the input image, and
the filtering of the input image according to the selected at least one filter mask comprises converting an input object pixel to an output object pixel by arbitrarily selecting a pixel value that surrounds the input object pixel in the input image as the output object pixel according to the corresponding pattern of the at least one filter mask.

20. The method of claim 9, wherein:
the determining of the pattern of the input image comprises computing a plurality of correlation coefficients by relating the plurality of predetermined masks having predetermined patterns to the input image so that a center of the plurality of predetermined masks is matched with an object pixel of the input image using at least one predetermined window matrix of the input image,
the selecting of the at least one filter mask that is most similar to the input image from the plurality of predetermined masks comprises determining the at least one filter to filter the object pixel of the input image by selecting one of the plurality of predetermined masks having a maximum correlation coefficient with the at least one predetermined window matrix, and
the filtering of the input image according to the selected at least one filter mask comprises performing a non-linear filtering to determine an output object pixel value of the input image using the determined at least one filter mask.

21. An apparatus to smooth a video signal using a pattern adaptive filtering, comprising:
a correlation measurement block to compute one or more correlation coefficients by relating one or more masks having predetermined patterns to an input image matrix so that a center of the one or more masks are matched with an object pixel of the input image matrix using at least one predetermined window matrix;
a pattern determination block to determine a filter mask to filter the object pixel of the input image by selecting one of the one or more masks having a maximum correlation coefficient with the at least one predetermined window matrix according to the computed one or more correlation coefficients; and
a pattern adaptive non-linear filter block to perform a non-linear filtering to determine an output object pixel value of the input image matrix using the determined filter mask.

22. The apparatus of claim 21, wherein the pattern adaptive non-linear filter block selects a value from among pixel values of the input image matrix that correspond to the predetermined pattern of the determined filter mask.

23. The apparatus of claim 21, wherein each of the one or more masks is a square matrix having a plurality of fields including a plurality of pattern fields filled with the same values and the plurality of pattern fields having the same values to define one of a unidirectional pattern, a bidirectional pattern, and an omnidirectional pattern.

24. The apparatus of claim 21, wherein each of the one or more masks is a square matrix having a plurality of fields including a plurality of pattern fields filled with different weighted values, and the weighted values define one of a unidirectional pattern, a bidirectional pattern, and an omnidirectional pattern.

25. The apparatus of claim 21, wherein each of the one or more masks is a square matrix having a plurality of fields including a plurality of pattern fields to define a corresponding pattern of the respective mask and is configured so that a sum of values filled in the selected ones of the plurality of fields equals 1 and a remainder of the plurality of fields are filled with zero.

26. The apparatus of claim 21, wherein the pattern adaptive non-linear filter block performs a non-linear filtering to select the output object pixel value from among pixel values of the at least one predetermined window matrix of the input image matrix that correspond to the predetermined pattern of the determined filter matrix.

27. The apparatus of claim 26, wherein the selected pixel value of the at least one predetermined window matrix is one of an intermediate value, a maximum value, and a minimum value of the pixel values of the at least one predetermined window matrix that correspond to the predetermined pattern of the determined filter mask.

28. The apparatus of claim 27, wherein the plurality of pattern fields define the corresponding pattern of determined filter mask and the non-linear filtering is performed according to:
Y(N)=med[X(n−K), . . . , X(n), . . . , X(n+K)],
where Y(N) is the output object pixel value, X(n) includes the values of the at least one predetermined window matrix that correspond to the plurality of pattern fields of the determined filter mask, med[ ] is a function that selects a median pixel value from among the X(n) values, and K is a variable that ranges from a negative to a positive value of: (a number of pattern fields−1)/2.

29. The apparatus of claim 21, wherein the one or more predetermined masks having predetermined patterns comprise a plurality of masks having predetermined patterns and all object pixels in the input image matrix are filtered according to a filter mask selected from the plurality of predetermined masks having a maximum correlation with pixels surrounding each of the object pixels.

30. An apparatus to filter an input image in a video signal, comprising:
a correlation measurement unit to determine a pattern of the input image by comparing the input image to a plurality of predetermined masks;
a pattern determination unit to select at least one filter mask that is most similar to the input image from the plurality of predetermined masks; and
a pattern adaptive filter unit to filter the input image according to the selected at least one filter mask.

31. The apparatus of claim 30, wherein:
the correlation measurement unit determines the pattern of the input image by determining at least one correlation between at least one predetermined mask having a corresponding pattern and each pixel in the input image,
the pattern determination unit selects the at least one filter mask that is most similar to the input image from the plurality of predetermined masks by selecting the at least one filter mask having a maximum correlation from the plurality of predetermined masks for each pixel in the input image, and
the pattern adaptive filter unit filters the input image according to the selected at least one filter mask by filtering each pixel in the input image according to the respective ones of the at least one filter mask for each pixel in the input image.

32. The apparatus of claim 30, wherein the correlation measurement unit determines the pattern of the input image for each pixel in the input image by defining a window matrix having pixel values of the input image including an object pixel at a center thereof, and comparing each of the plurality of predetermined masks with the window matrix to measure a similarity between the window matrix and each of the plurality of predetermined masks.

33. The apparatus of claim 32, wherein each of the plurality of predetermined masks has a plurality of pattern fields and non-pattern fields to define a corresponding pattern, and the window matrix has a plurality of fields including pixel values of the input image.

34. The apparatus of claim 33, wherein when the object pixel is close to an edge of the input image, the correlation measurement unit determines unfilled fields in the window matrix that do not have a corresponding input image pixel value, and fills the unfilled fields in the window matrix with a nearest corresponding input image pixel value.

35. The apparatus of claim 30, wherein the pattern determination unit selects the at least one filter mask that is most similar to the input image for each pixel in the input image by comparing a matrix window having pixel values of the input image including an object pixel at a center thereof to each of a plurality of predetermined masks, and selecting the filter mask that is most similar to the matrix window according to the pixel values in the matrix window and patterns of each of the plurality of predetermined masks.

36. The apparatus of claim 30, wherein the pattern adaptive filter unit filters the input image according to the selected at least one filter mask by performing a non-linear filtering process performed on each of the pixels in the input image.

37. The apparatus of claim 30, wherein each of the plurality of predetermined masks comprises a plurality of pattern fields and non-pattern fields to define a corresponding pattern, and a window matrix of the input image having an input object pixel at a center thereof includes a plurality of fields including pixel values of the input image, and the pattern adaptive filter unit performs the non-linear filtering process for each pixel in the input image by comparing the matrix window of the input image having the input object pixel at the center thereof to the selected filter mask to determine pixel values of fields in the matrix window that correspond to the pattern fields in the selected filter mask, and selecting one of the pixel values of the fields in the matrix window that correspond to the pattern fields in the selected filter mask as an output object pixel value.

38. The apparatus of claim 37, wherein the pattern adaptive filter unit selects one of the pixel values of the fields in the matrix window that correspond to the pattern fields of the selected filter mask comprises selecting one of a median pixel value, a maximum pixel value, and a minimum pixel value.

39. The apparatus of claim 30, wherein each of the plurality of predetermined masks has a predetermined mask size that corresponds to a portion of the input image to filter an object pixel of the input image, and the plurality of predetermined masks include at least one of a bidirectional pattern, a unidirectional pattern, and an omnidirectional pattern.

40. The apparatus of claim 30, wherein:
the correlation measurement unit determines the pattern of the input image by determining at least one pattern of the input image according to a comparison of the plurality of predetermined masks having corresponding patterns to the input image,
the pattern determination unit selects tat at least one filter mask that is most similar to the input image by selecting the at least one filter mask from the plurality of predetermined masks that has a corresponding pattern that is similar to the at least one pattern of the input image, and
the pattern adaptive filter unit filters the input image according to the selected at least one filter mask by converting an input object pixel to an output object pixel by arbitrarily selecting a pixel value that surrounds the input object pixel in the input image as the output object pixel according to the corresponding pattern of the at least one filter mask.

41. The apparatus of claim 30, wherein:
the correlation measurement unit determines the pattern of the input image by computing a plurality of correlation coefficients by relating the plurality of predetermined masks having predetermined patterns to the input image so that a center of the plurality of predetermined masks are matched with an object pixel of the input image using at least one predetermined window matrix,
the pattern determination unit selects tat at least one filter mask that is most similar to the input image by determining the at least one filter mask to filter the object pixel of the input image by selecting one of the plurality of predetermined masks having a maximum correlation coefficient with the at least one predetermined window matrix according to the computed plurality of correlation coefficients, and
the pattern adaptive filter unit filters the input image according to the selected at least one filter mask by performing a non-linear filtering to determine an output object pixel value of the input image using the determined at least one filter mask.
